(19) United States
(12) Patent Application Publication
(10) Pub. No.: US 2024/0183611 A1
(43) Pub. Date: Jun. 6, 2024

(54) DRYING APPARATUS

(71) Applicants: Tae-Wook KIM, Seoul (KR); MUGOONGMUJIN CO., LTD., Seoul (KR)

(72) Inventor: Tae-Wook KIM, Seoul (KR)

(73) Assignees: Tae-Wook KIM, Seoul (KR); MUGOONGMUJIN CO., LTD., Seoul (KR)

(21) Appl. No.: 18/287,625

(22) PCT Filed: Apr. 14, 2022
(86) PCT No.: PCT/KR2022/005428

§ 371 Date: Oct. 19, 2023

(30) Foreign Application Priority Data
Apr. 19, 2021 (KR) 10-2021-0050698

(51) Int. Cl. F26B 3/04; F26B 21/04

(52) U.S. Cl. CPC F26B 3/04; F26B 21/04

(57) ABSTRACT

The present invention relates to a drying apparatus in which objects to be dried are loaded and dried by wind and lamp heat, and has the specific features in which: the drying apparatus is divided into an upper machine room and a lower drying room by a partition plate that is parallel to the ground and installed inside a cylindrical case having closed upper and lower surfaces; an inner case, which is installed spaced apart from the inner surface of the case and has a plurality of through-holes, is installed inside the drying room; and an object loading device, in which the objects to be dried by heat from a lamp are loaded, is rotatably installed in a cylindrical space formed by the inner case.

### TECHNICAL FIELD

The present invention relates to a circular-type drying apparatus, which is a circular type, retains a drying target therein, and dries the drying target through rays and ventilation.

### BACKGROUND ART

Korean Patent Registration No. 10-2123389 (Invention Title: Drying Target Dryer) (hereinafter referred to as “related art”), which is an apparatus that retains a drying target therein and dries the drying target through near-infrared rays and ventilation, has been developed.

FIG. 1a is a sectional view for describing an overall configuration of the related art, and FIG. 1b is a perspective view showing an air flow introduction unit of the related art.

According to the related art, a drying target dryer 1 may include: a main body 10 including a ventilation hole 11 formed on an upper side of the main body 10 and a door for opening and closing an inner space that is open; a drying rack 20 rotatably installed in the inner space of the main body 10, and to which a drying target is fixed; an insulating material 30 installed along an inner wall of the main body 10 to maintain inner heat; an air flow introduction unit 40 installed to overlap one inner surface of the insulating material 30, and through which air is introduced from the ventilation hole to flow toward the drying rack; an air flow exhaust unit 50 installed to overlap an opposite inner surface of the insulating material 30 to face the air flow introduction unit 30, and through which the air that has passed through the drying rack 20 is introduced to flow toward the ventilation hole 11; a circulation fan 60 installed between the ventilation hole 11 and the air flow introduction unit 30 and configured to allow the air introduced from the ventilation hole 11 to flow to the air flow introduction unit; and a near-infrared lamp 70 installed at a center of one surface of each of the air flow introduction unit 40 and the air flow exhaust unit 50 and configured to emit near-infrared rays toward the drying target fixed to the drying rack, wherein the air flow introduction unit 40 includes: a first surface 41 making contact with one inner surface of the insulating material 30; a second surface 42 facing the inner space of the main body, and in which a plurality of recess spaces having widths that gradually become narrower toward the first surface are arranged in a lateral direction; a separation space 43 formed between the first surface 41 and the second surface 42, and into which the air is introduced from the ventilation hole 11; and a plurality of introduction holes 44 formed in the recess spaces of the second surface 42, configured to allow the air introduced into the separation space to flow into the inner space of the main body, and forming a plurality of layers in a longitudinal direction of the recess spaces, and the introduction holes include: a first introduction hole 44a located at a center of each of the recess spaces in a width direction; and a second introduction hole 44b formed at positions having bilateral symmetry about the first introduction hole 44a.

According to the related art described above, as shown in FIG. 1b, the main body 10 may have a polygonal shape, particularly a rectangular shape as a sectional shape of the main body, with a wall formed of the insulating material 30 having a straight line shape, the drying rack 20 installed inside the main body 10 may be a structure rotated by a motor, in which the structure has upper and lower frames having a circular shape to rotate, so that a wide separation portion and a narrow separation portion may exist between an inside of the main body and a space where the drying rack 20 rotates, and thus drying efficiency may be reduced by a wind that is not uniformly emitted to the drying target dried on the drying rack 20, and a noise may be generated by different separation spaces.

In addition, according to the related art, since a recess portion at a center of the second surface 42 and inclined portions deployed on both sides of the recess portion have to be inclined at a precise symmetrical angle, and the first introduction hole 44a formed in the recess portion and the second introduction hole 44b formed in the inclined portion have to be drilled at precise locations in order to form a vortex by an emitted wind, manufacture of the second surface 42 and the drilling of the introduction holes have to be performed with precision, and in this process, defective products may be mass-produced.

In addition, according to the related art, since a wind flowing to the air flow exhaust unit 50 and a wind introduced from the ventilation hole 11 flow to the air flow introduction unit 30 depending on the circulation fan 60, strength of the wind flowing in the air flow introduction unit 30 may not be increased beyond a predetermined level, and when the strength of the wind is excessively increased, the circulation fan may generate a great noise, and the circulation fan may be overloaded.

### DISCLOSURE

### Technical Problem

The present invention has been devised to solve the problems of the related art described above, and an object of the present invention is to form a sectional shape of a main body in a circular shape of a polygonal shape, which is an octagonal or higher polygonal shape that is close to the circular shape, so as to allow a space between a rotation frame rotating inside the main body and an inner case of the main body to be uniform, so that drying efficiency may be increased, and a noise may be reduced.

Another object of the present invention is to form the inner case in a circular shape, and to form an air emission hole and an air suction hole without forming a recess portion in the inner case, so that a vortex may be efficiently generated without precision processing.

Still another object of the present invention is to allow a drying target loading device inside the main body to be structurally stable while providing convenience in loading a drying target, so that drying may be efficiently performed.

Other objects of the present invention will be described through embodiments that will be described below.

### Technical Solution

To achieve the objects described above, according to the solution, there is provided a drying apparatus in which a drying target is loaded and dried by a wind and heat of a lamp, wherein the drying apparatus is divided into an upper machine room and a lower drying room by a partition plate, which is installed parallel to a ground inside a case having a cylindrical shape and closed top and bottom surfaces, an inner case, which is spaced apart from an inner surface of the case and has a plurality of through-holes, is installed inside the drying room, and a drying target loading device in which the drying target dried by the heat of the lamp is loaded is rotatably installed in a cylindrical space formed by the inner case.

In addition, according to the present invention, the drying target loading device may preferably include: a rotation plate having a disc shape and rotated by a rotational force of a motor installed in the machine room; a plurality of horizontal bars having one ends coupled to the rotation plate and installed parallel to the ground; vertical bars coupled to opposite ends of the horizontal bars and installed perpendicular to the ground, respectively; and a plurality of horizontal bars having one ends coupled to lower ends of the vertical bars, respectively, and opposite ends coupled to a rotation plate having a disc shape.

In addition, according to the present invention, at least one fan may be preferably installed on an upper portion of the partition plate, air discharged by the fan may be preferably sprayed to the drying target loading device through the through-holes formed on one side of the inner case and sucked through the through-holes formed on an opposite side of the inner case, and the air sucked through the through-holes formed on the opposite side of the inner case may be preferably discharged to the upper portion of the partition plate.

In addition, according to the present invention, a pump may be preferably installed on the upper portion of the partition plate to discharge the air sucked through the through-holes formed on the opposite side of the inner case to an outside.

In addition, according to the present invention, the air sucked through the through-holes formed on the opposite side of the inner case may be preferably re-introduced into the fan.

In addition, according to the present invention, the horizontal bars having the one ends coupled to the rotation plate and installed parallel to the ground and the vertical bars coupled to the opposite ends of the horizontal bars and installed perpendicular to the ground, respectively, may preferably form three pairs installed to face each other

In addition, according to the present invention, heating lamps may be preferably installed symmetrically about a center point of the inner case in the inner case.

In addition, according to the present invention, the vertical bars may preferably have a plurality of incision portions arranged in a vertical direction and having one side that is open, and a plurality of insertion portions configured as grooves consecutively formed downward on inner sides of the incision portions.

In addition, according to the present invention, since an inner surface of the inner case has a high reflectivity, and lights are emitted from the heating lamps in various directions and reflected on the inner surface of the inner case in various directions, the drying target arranged about the center point (O) of a circle formed by the inner case may be preferably uniformly dried.

In addition, according to the present invention, since the lights emitted from the heating lamps arranged symmetrically about the center point (O) of the inner case have traveling directions matching each other so as to overlap each other, and the overlapping lights cause constructive interference, light amplification may preferably occur to increase heating efficiency.

In addition, according to the present invention, the drying target may be preferably sterilized and heated at a temperature of 30° to 160°.

### Advantageous Effects

According to the present invention having the objects and solutions described above, the case and the inner case may have a cylindrical shape or a polygonal shape that is close to the cylindrical shape, so that when the drying target loading device is rotated, a noise or a vibration can be significantly reduced as compared with a structure configured as a rectangular prism body.

In addition, according to the present invention, a structure of the drying target loading device can enable easy assembly and allow a loaded drying target to be easily removed or inserted.

In addition, a circulation structure in which air that has passed through the drying target is sucked and discharged again through a fan may be formed, so that a drying time can be shortened.

In addition, inclinations of a latching rack and a drying net may be adjusted and installed in multiple stages, so that the drying target can be efficiently dried by changing the inclinations according to a condition of the drying target.

### DESCRIPTION OF DRAWINGS

FIG. 1a is a sectional view for describing an overall configuration of the related art, and FIG. 1b is a perspective view showing an air flow introduction unit of the related art.

FIG. 2 is a perspective view for describing an overall configuration of the present invention.

FIG. 3 is a sectional view of FIG. 2.

FIG. 4 is a perspective view showing a coupling state of a rotation plate and horizontal bars according to the present invention.

FIG. 5 is a layout view showing a motor and a pump installed on a top surface of a partition plate according to the present invention.

FIG. 6 is a view showing a configuration of a controller according to the present invention.

FIG. 7 is a view showing a configuration of an inner case according to the present invention.

FIG. 8 is a sectional view for describing an arrangement of heating lamps according to the present invention.

FIG. 9 is a plan view showing a latching rack according to the present invention.

FIG. 10 is a perspective view showing a vertical bar according to the present invention.

FIG. 11 is an internal perspective view for describing another embodiment of the present invention.

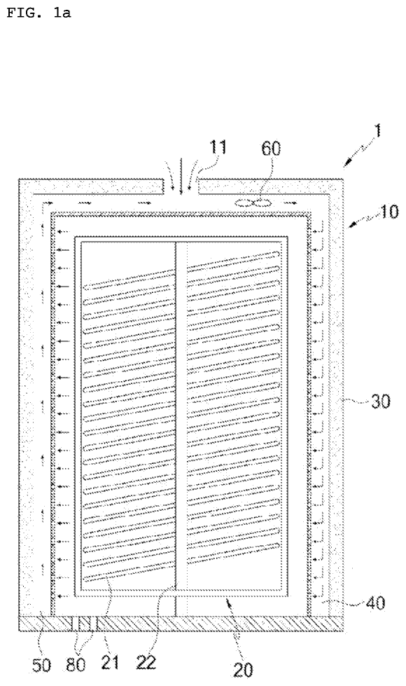

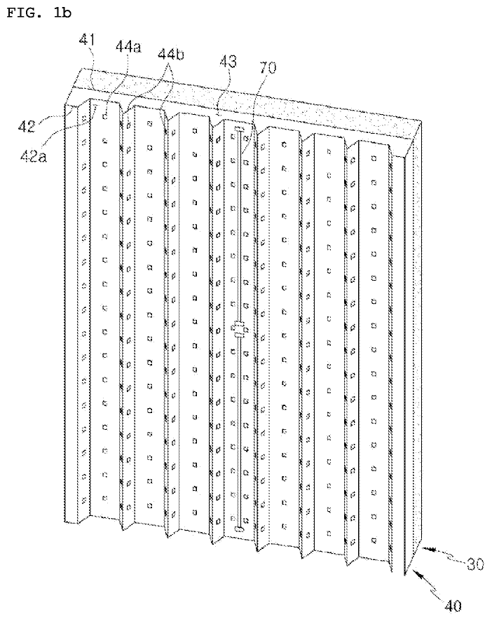

### BEST MODE

Hereinafter, an embodiment of the present invention will be described in detail with reference to the accompanying drawings.

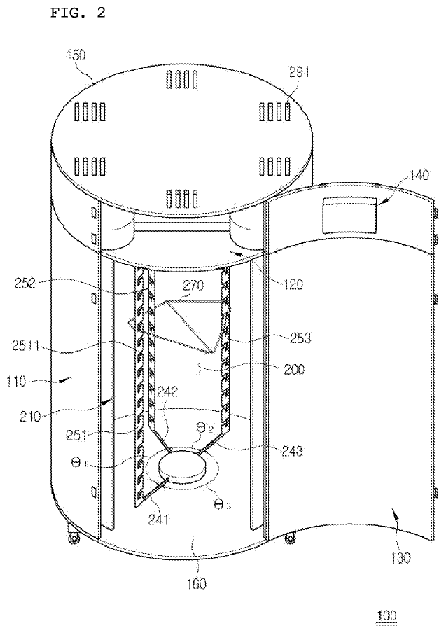

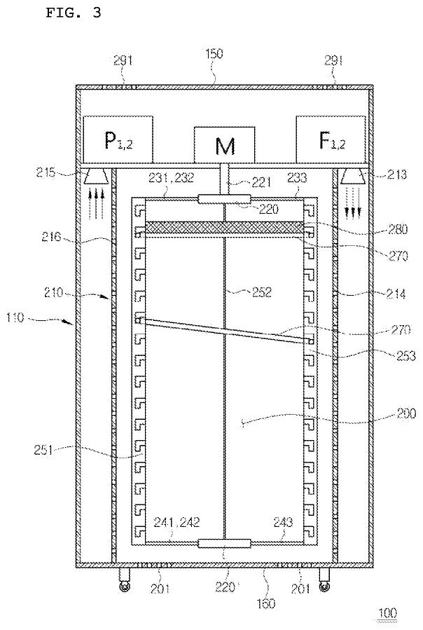

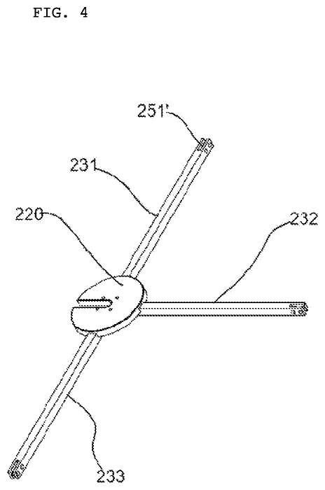

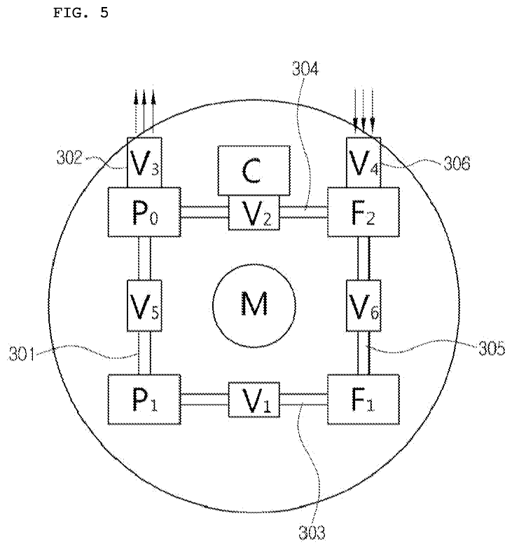

FIG. 2 is a perspective view for describing an overall configuration of the present invention, FIG. 3 is a sectional view of FIG. 2, FIG. 4 is a perspective view showing a coupling state of a rotation plate and horizontal bars according to the present invention, and FIG. 5 is a layout view showing a motor and a pump installed on a top surface of a partition plate according to the present invention.

According to the present invention, a sectional shape of a drying apparatus 100 may be a circular shape or a polygonal shape that is close to the circular shape so that an overall external shape of the drying apparatus 100 may be a cylindrical shape when viewed from an outside.

A partition plate 120 may be installed close to a top surface 150 of the drying apparatus 100 inside a case 110 having a cylindrical shape and closed by the top surface 150 and a bottom surface 160 of the drying apparatus 100, a space between a top surface of the partition plate 120 and an upper end surface of the case 110 may be a machine room in which suction pumps P1 and P2, discharge fans F1 and F2, a motor M, and the like, which will be described below, are installed, and a space between a bottom surface of the partition plate 120 and a lower end surface of the case 110 may form a drying room 200.

A machine room opening/closing door 140 may be installed at a front surface of the space forming the machine room, a switch, a display panel, a lamp, and the like, which are not shown in the drawings, may be installed on a front surface of the machine room opening/closing door 140 so that the switch may be operated, or an operating state of a machine may be observed from the outside, a circuit board unit 140 in which such elements are connected may be installed on a rear surface of the machine room opening/closing door, and the circuit board unit 140 may be connected to a controller C by a wire that is not shown in the drawings.

In addition, an opening/closing door 130 may be installed on a front surface of the case 110 forming the drying room 200, an inner case 210 may be installed inside the case 110 while being spaced apart from an inner surface of the case 110, an emission unit 213 for the fans F1 and F2 may be installed on one side of a space formed by the inner case 210 and the case 110 to allow a discharged wind to be introduced, and a suction port 215 for the pumps P1 and P2 may be installed on an opposite side of the space to allow the air to be sucked by the pumps P1 and P2.

In this case, through-holes may be formed in the inner case 210 at regular intervals in longitudinal and lateral directions, an emission hole 214 may be formed in a portion adjacent to the emission unit 213 for the fans F1 and F2 to serve as an air emission hole that allows the air discharged from the emission unit 213 to be introduced into the drying room 200, and a suction hole 216 adjacent to the suction port 215 may suck the air inside the drying room 200 to transfer the air to the pumps P1 and P2.

In addition, the motor M may be installed in the machine room, and a rotation shaft 221 rotated by the motor M may be installed at a center of the drying room 200. In this case, as shown in FIG. 3, the rotation shaft 221 may be, but is not limited to, a device that is directly connected to a rotation shaft of the motor M to rotate, and the rotation shaft 221 may be coupled to the rotation shaft of the motor M with a belt to rotate, and may be coupled by a gearbox to rotate with a varying rotation speed.

In addition, a drying target loading device may be installed inside the drying room 200. The drying target loading device may include: a rotation plate 220 installed at a lower end of the rotation shaft 221; horizontal bars 231, 232, and 233 having one ends coupled to the rotation plate 220 and installed parallel to a ground; vertical bars 251, 252, and 253 coupled to opposite ends of the horizontal bars 231, 232, and 233 and installed perpendicular to the ground, respectively; horizontal bars 241, 242, and 243 having one ends coupled to lower ends of the vertical bars, respectively, and opposite ends coupled to a rotation plate; a latching rack 270 to which the vertical bars 251, 252, and 253 are latched; and a drying net 280 suspended from an upper portion of the latching rack 270.

In addition, an insertion groove 251′ may be formed at ends of the horizontal bars 231, 232, and 233 and the horizontal bars 241, 242, and 243 so that the vertical bars 251, 252, and 253 may be inserted into the insertion grooves 251′ and coupled by a coupling device such as a rivet, and since the upper and lower horizontal bars are coupled to each other by the vertical bars, the upper and lower horizontal bars may be installed to face each other in a vertical direction.

In this case, an angle θ1 between the horizontal bar 241 and the horizontal bar 242 and an angle θ2 between the horizontal bar 242 and the horizontal bar 243 may be equal to each other, and it may be advantageous for an angle θ3 between the horizontal bar 243 and the horizontal bar 241 to be greater than 01, preferably 180º, to facilitate loading or removing a drying target to or from the mounting rack 270, but the present invention is not limited thereto.

In addition, an exhaust hole 291 may be formed on a top surface of the machine room to allow the air inside the machine room to be discharged to the outside, and a discharge hole 201 may also be formed on a bottom surface of the drying room 200 so that moisture falling on the bottom surface upon drying the drying target may be discharged, and the moisture may be discharged to the outside upon cleaning the drying room.

As shown in FIG. 5, the controller C may be installed in the machine room to drive the pumps P1 and P2, the fans F1 and F2, and valves V1, V2, V3, V4, V5, and V6 by an input switch signal and detection signals of a thermometer and a hygrometer.

The pump P1 and the pump P2 may connected to each other by a connection pipe 301 provided with the valve V5 that is opened and closed by a driving signal of the controller C, the pump P2 may be provided with a discharge pipe 302 for discharging the air to the outside through the valve V3, a connection pipe 303 provided with the valve V1 may be installed between the pump P1 and the fan F1, a connection pipe 304 provided with the valve V2 may be installed between the pump P2 and the fan F2, a connection pipe 305 provided with the valve V6 may be installed between the fan F1 and the fan F2, and the fan F2 may be provided with a suction pipe 306 for sucking the air from the outside through the valve V4.

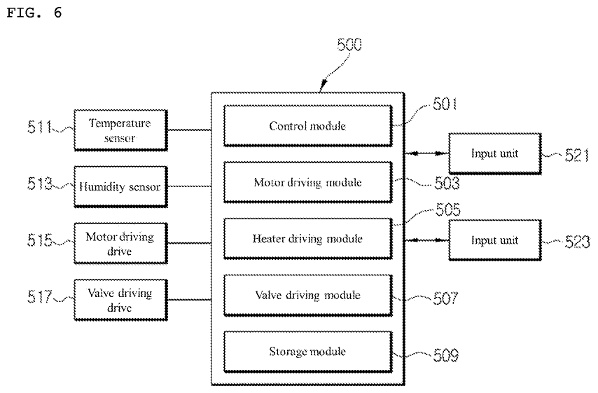

FIG. 6 is a view showing a configuration of a controller according to the present invention.

The controller C may be configured based on a microcontroller unit (MCU) 500, and the microcontroller unit 500 may include: a control module 501 for receiving data from a control target connected to an operating system (OS) that operates a system or an internal module to perform operation processing, and outputting calculated data to an external control target or the internal module; a motor driving module 503 for reading a motor driving pattern stored in a storage module 509 to supply a motor driving signal to a motor driving drive 515; a heater driving module 509 for generating an on-off signal for a heater by comparing signals input from a temperature sensor 511 and a humidity sensor 513 with set temperature data and humidity temperature data stored in the storage module 509; a valve driving module 507 for generating a valve driving signal for opening and closing a specific valve according to a temperature and a humidity detected by the temperature sensor 511 and the humidity sensor 513 to supply the valve driving signal to a valve driving drive 517; the storage module 509 for storing specific values, including a reference value, input through an input unit 521; and a display unit 523 for displaying a value output from the control module 501.

In this case, the motor driving module 503 may drive the motor M according to a dynamic pattern determined variously according to a rotation speed, a forward rotation time, and a reverse rotation time of the rotation shaft 220 input by the input unit 521 and stored in the storage module 509.

In addition, the heater driving module 505 may heat the heater that will be described below when the temperature and the humidity detected by the temperature sensor 511 and humidity sensor 513 installed in the drying room 200 are lower than a reference temperature previously stored in the storage module 509 and higher than a reference humidity previously stored in the storage module 509, respectively.

In addition, when the temperature inside the drying room 200 is lower than the previously stored reference temperature, the valve driving module 507 may close the valves V3, V4, V5, and V6 and open the valves V1 and V2 to allow the air sucked by the pumps P1 and P2 to be discharged and emitted by the fans F1 and F2 so that the temperature inside the drying room 200 may be rapidly increased, and thus a drying speed may be increased, and electrical efficiency may be improved.

However, when the temperature is greater than or equal to a preset temperature according to the input from the input unit 521, the valves V3, V4, V5, and V6 may be opened while the valves V1 and V2 are closed for a set time for each predetermined period, so that the air inside the drying room 200 may be set to be clean by sucking new air from the outside.

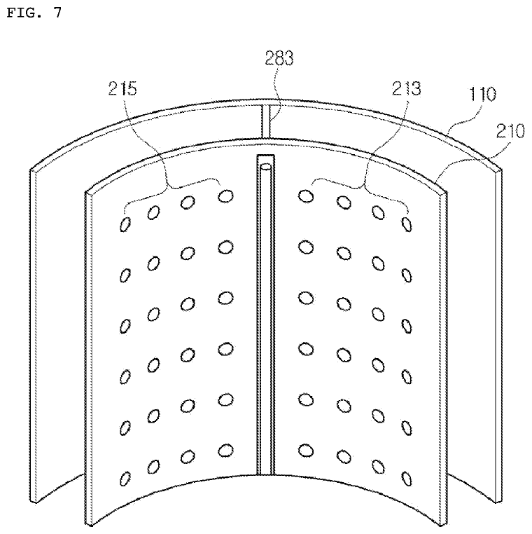

FIG. 7 is a view showing a configuration of an inner case according to the present invention.

As shown in FIG. 7, an air separation plate 283 for separating air suction and air discharge spaces from each other may be formed in the vertical direction between a circumferential center of the inner case 210 and the case 110, an emission hole 214 may be formed in a region adjacent to the emission unit 213 in a space divided by the air separation plate 28, and a suction hole 216 may be formed in a region in which the suction port 215 is installed. In addition, due to the air separation plate 28, all the air emitted from the emission unit 213 may be emitted through the emission hole 214 and introduced into the drying room 200, so that an air flow may be strengthened.

Since the air emitted through the emission hole 214 formed as described above is discharged toward a center of a circle of the inner case 210, the air may crosses each other, so that a vigorous vortex may be formed without particularly forming an inclined portion or processing a crease in the inner case 210.

In addition, the inner case 210 may have a groove in the vertical direction, and a lamp for drying the drying target, preferably a near-infrared lamp, may be installed in the groove in the vertical direction to apply heat to the drying target.

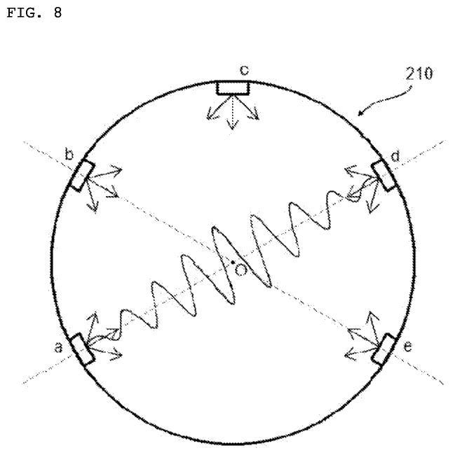

FIG. 8 is a sectional view for describing an arrangement of heating lamps according to the present invention.

Heating lamps a, b, c, d, and e for heating a plurality of drying targets may be installed in the inner case 213, and the inner case 213 may be fabricated by using a stainless steel mirror or may have the inner surface plated with a metal having a high reflectivity, so that an entire incident light may be reflected. Since lights are emitted from the heating lamps installed in the inner case in various directions and reflected on the inner surface of the inner case 213 in various directions, the drying target arranged about a center point O of a circle formed by the inner case may be uniformly dried, so that drying uniformity may be increased.

In addition, since the lamps a and d and the lamps b and e are arranged symmetrically about the center point O of the inner case 213, the lights emitted from the symmetrical lamps may have traveling directions matching each other so as to overlap each other, and the overlapping lights may cause constructive interference, so that light amplification may occur, and thus the drying target may be heated with higher heat to increase heating efficiency.

In addition, the lamps 280 may sterilize and heat the drying target at a temperature of 30° to 160°, and the drying target that has been dried may be separately sterilized inside a dryer. A heating temperature may be adjusted by an input tool installed on the opening/closing door 140.

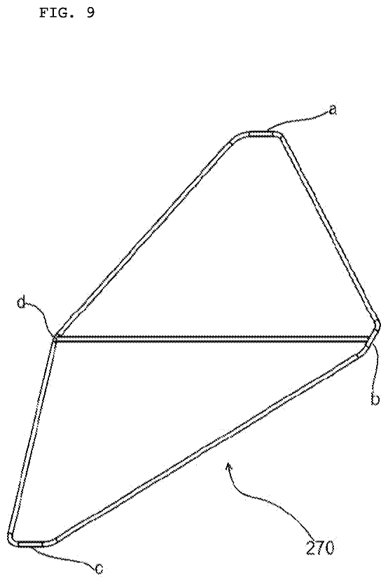

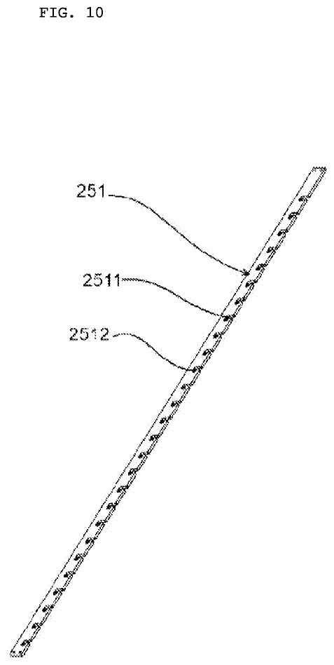

FIG. 9 is a plan view showing a latching rack according to the present invention, and FIG. 10 is a perspective view showing a vertical bar according to the present invention.

The vertical bars may have a plurality of insertion portions formed in the vertical direction, into which the latching rack may be inserted. The insertion portion may have incision portions 2511 having one side that is open, and grooves 2512 consecutively formed downward on inner sides of the incision portions 2511, so that the latching rack 270 may be inserted into the insertion portion so as not to be separated.

The latching rack 270 may include four bars forming outer periphery sides, and a bar for connecting a side b in which the bars meet each other to a contact point d, and the drying net 280 on which the drying target may be stacked may be mounted on the latching rack 270. In addition, each of sides a and c of the latching rack 270 facing each other may have a length that is shorter than a length of each of the other bars, and the sides may be pushed into the incision portions 2511 of the vertical bars 251, 252, and 253, respectively, and inserted into the grooves 2512.

In addition, the side b may be inserted into the groove of the vertical bar 252, so that the latching rack 270 may be mounted on the vertical bars. When the drying target has little moisture, the latching rack 270 may be fitted to the grooves 2512 of the vertical bars 251, 252, and 253 at positions that are parallel to the latching rack 270, and when the drying target has much moisture, the latching rack 270 may be preferably fitted to the grooves 2512 at positions having levels that are different from a level of the latching rack 270 so as to be inclined.

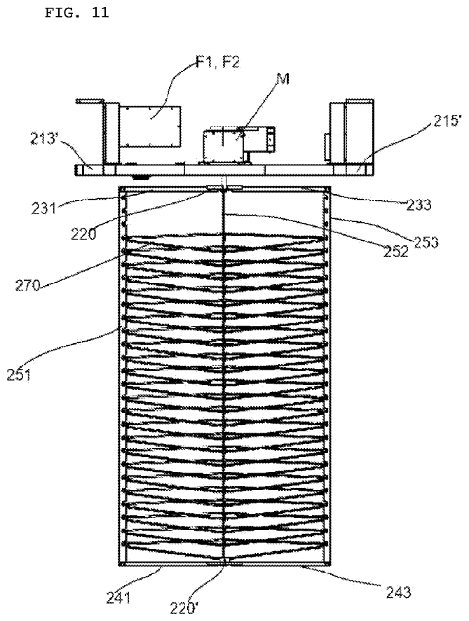

FIG. 11 is an internal perspective view for describing another embodiment of the present invention.

FIG. 11 shows a simplified embodiment as compared with the embodiment shown in FIGS. 2, 3, and 4, in which the same parts such as the case and the inner case have been omitted for convenience of description, and since the configuration of the loading target loading device is the same, the same number will be assigned, and detailed descriptions will be omitted.

In FIG. 11, the air emitted from the fans F1 and F2 may be introduced into the space between the case and the inner case 210 through an emission unit 213′, may dry the drying target through the emission hole 214 of the inner case 210, may be introduced into the space between the inner case 210 and the case through the suction hole 216 on an opposite side, and may be discharged to the outside through a suction unit 215′.

As described above, the present invention may be modified into various embodiments, and it will be apparent that an effect of the present invention extends even to the modified embodiments, so that the scope of the present invention should be determined by the claims.

1. A drying apparatus in which a drying target is loaded and dried by a wind and heat of a lamp, wherein the drying apparatus is divided into an upper machine room and a lower drying room by a partition plate, which is installed parallel to a ground inside a case having a cylindrical shape and closed top and bottom surfaces,
an inner case, which is spaced apart from an inner surface of the case and has a plurality of through-holes, is installed inside the drying room, and
a drying target loading device in which the drying target dried by the heat of the lamp is loaded is rotatably installed in a cylindrical space formed by the inner case.

2. The drying apparatus of claim 1, wherein the drying target loading device includes:
a rotation plate having a disc shape and rotated by a rotational force of a motor installed in the machine room;
a plurality of horizontal bars having one ends coupled to the rotation plate and installed parallel to the ground;
vertical bars coupled to opposite ends of the horizontal bars and installed perpendicular to the ground, respectively; and
a plurality of horizontal bars having one ends coupled to lower ends of the vertical bars, respectively, and opposite ends coupled to a rotation plate having a disc shape.

3. The drying apparatus of claim 2, wherein at least one fan is installed on an upper portion of the partition plate, air discharged by the fan is sprayed to the drying target loading device through the through-holes formed on one side of the inner case and sucked through the through-holes formed on an opposite side of the inner case, and the air sucked through the through-holes formed on the opposite side of the inner case is discharged to the upper portion of the partition plate.

4. The drying apparatus of claim 3, wherein a pump is installed on the upper portion of the partition plate to discharge the air sucked through the through-holes formed on the opposite side of the inner case to an outside.

5. The drying apparatus of claim 3, wherein the air sucked through the through-holes formed on the opposite side of the inner case is re-introduced into the fan.

6. The drying apparatus of claim 2, wherein the horizontal bars having the one ends coupled to the rotation plate and installed parallel to the ground and the vertical bars coupled to the opposite ends of the horizontal bars and installed perpendicular to the ground, respectively, form three pairs installed to face each other

7. The drying apparatus of claim 1, wherein heating lamps are installed symmetrically about a center point of the inner case in the inner case.

8. The drying apparatus of claim 2, wherein the vertical bars have a plurality of incision portions arranged in a vertical direction and having one side that is open, and a plurality of insertion portions configured as grooves consecutively formed downward on inner sides of the incision portions.

9. The drying apparatus of claim 7, wherein, since an inner surface of the inner case has a high reflectivity, and lights are emitted from the heating lamps in various directions and reflected on the inner surface of the inner case in various directions, the drying target arranged about the center point (O) of a circle formed by the inner case is uniformly dried.

10. The drying apparatus of claim 9, wherein, since the lights emitted from the heating lamps arranged symmetrically about the center point (O) of the inner case have traveling directions matching each other so as to overlap each other, and the overlapping lights cause constructive interference, light amplification occurs to increase heating efficiency.

11. The drying apparatus of claim 10, wherein the drying target is sterilized and heated at a temperature of 30° to 160°.
